(19) United States
(12) Patent Application Publication
(10) Pub. No.: US 2020/0120083 A1
(43) Pub. Date: Apr. 16, 2020

(54) TIME-BASED DETAIL DEGRADATION FOR AUTHORIZATION SCOPES

(71) Applicant: CA, Inc., New Y ork, NY (US)

(72) Inventors: Mohammed Mujeeb Kaladgi, Bangalore (IN); Ruqiya Nikhat Kaladgi, Bangalore (IN)

(21) Appl. No.: 16/159,576

(22) Filed: Oct. 12, 2018

(51) Int. Cl. H04L 29/06; G06F 21/33; H04L 9/32

(52) U.S. Cl. CPC H04L 63/0807; H04L 63/0815; G06F 21/335; H04L 63/108; G06F 2221/2137; H04L 9/3234; H04L 2209/04; H04L 2209/16; H04L 63/102

(57) ABSTRACT

To limit client application access to user information in a token-based authorization framework, access scopes can be degraded with age to incrementally restrict access privileges. This age-based scope degradation imposes time restrictions on the degree of detail of user resources which a resource server shares with a client application. When the client application attempts to access a resource with an access token issued for a specified scope, the age of the access token since it was first issued is measured. An authorization server determines a level of detail at which to share the user resource based on the age. The resource server then shares the user resource at the determined level of detail with the client application after some degree of reduction in detail, such as masking or altering according to the determined detail level. Scope degradation continues as specified until reaching a lowest detail level or visibility level.

### BACKGROUND

The disclosure generally relates to the field of information security, and more particularly to multicomputer data transferring.

The Open Authorization 2.0 protocol (OAuth) is a protocol that establishes a framework for token-based authentication and authorization across the Internet. According to the Internet Engineering Task Force (IETF) Request for Comments (RFC) 6749, the OAuth 2.0 authorization framework enables a third-party application (“client application”) to obtain limited access to a hypertext transfer protocol (HTTP) service, either on behalf of a resource owner by orchestrating an approval interaction between the resource owner and the HTTP service, or by allowing the client application to obtain access on its own behalf. OAuth introduces an authorization layer between the client application and the resource owner. The client application requests access to protected resources controlled by the resource owner and hosted by a resource server. The client application is issued a different set of credentials than those of the resource owner. Instead of using the resource owner's credentials to access the protected resources, the client application obtains an access token, which is implemented as a string denoting a specific access scope, lifetime, and other access attributes. An authorization server issues the access token to access a protected resource with the approval of the resource owner. The client application uses the access token to access the protected resources hosted by the resource server. The application can access the user resource until the access token expires, after which a refresh token may be used to obtain a new access token.

### BRIEF DESCRIPTION OF THE DRAWINGS

Embodiments of the disclosure may be better understood by referencing the accompanying drawings.

FIG. 1 is a conceptual diagram of scope degradation to limit client application access to protected resources in a token-based authorization framework.

FIG. 2 is a flowchart of example operations for determining a degraded scope level to assign to an access token.

FIG. 3 is a flowchart of example operations for determining a detail level at which a protected resource is to be shared with a client application.

FIG. 4 depicts an example computer system with a token validator and a scope degradation manager for assigning a degrading scope level to an access token and determining a level of detail at which a protected resource should be shared with a client application.

### DESCRIPTION

The description that follows includes example systems, methods, techniques, and program flows that embody aspects of the disclosure. However, it is understood that this disclosure may be practiced without these specific details. For instance, this disclosure refers to OAuth access grant flows in illustrative examples. Aspects of this disclosure can be instead applied to any token-based authorization framework grant type. In other instances, well-known instruction instances, protocols, structures and techniques have not been shown in detail in order not to obfuscate the description.

### OVERVIEW

Although a token-based authorization framework can define access scope for a client application to access a protected resource, that access scope persists with the token. Although a resource owner may wish to grant access to a protected resource at some point, enduring static access scope does not adapt to the fluidity of data privacy concerns and challenges of vast amounts of personally identifiable information on resource servers being available to client applications. To further limit client application access to user information in a token-based authorization framework, access scopes can be degraded with age to incrementally restrict access privileges. This age-based scope degradation imposes time restrictions on the degree of detail of user resources shared by the resource server with the client application. When the client application attempts to access a resource with an access token issued for a specified scope, the age of the access token since first issued to the client application is measured. An authorization server determines a level of detail at which to share the user resource based on the age. The resource server then shares the user resource at the determined level of detail with the client application after some degree of reduction in detail, such as masking or altering according to the determined detail level. For example, an access scope for an email address may be degraded after a week by masking out a portion of the prefix of the email address. As another example, an access scope for a date of birth scope may be degraded with age by incrementally removing the date, month, and year until a general age range remains. Scope degradation continues as specified until reaching a lowest detail level or visibility level.

Though the client application may present the resource server with a refresh token to obtain a new access token, the detail level will not refresh or reset to correspond to the new access token time of issue. The client application is therefore unable to receive refreshed visibility, and scope degradation continues with age of the original access token issuance. The initial level of detail can be restored when the client application re-authenticates and obtains a new access token. Age-based scope degradation prevents a client application from long-term or indefinite visibility of protected resources. Additionally, by limiting the time period during which a client application can access protected user resources, scope degradation reduces the risks of exposure of protected user resources by the client application and third-party applications without user awareness.

### EXAMPLE ILLUSTRATIONS

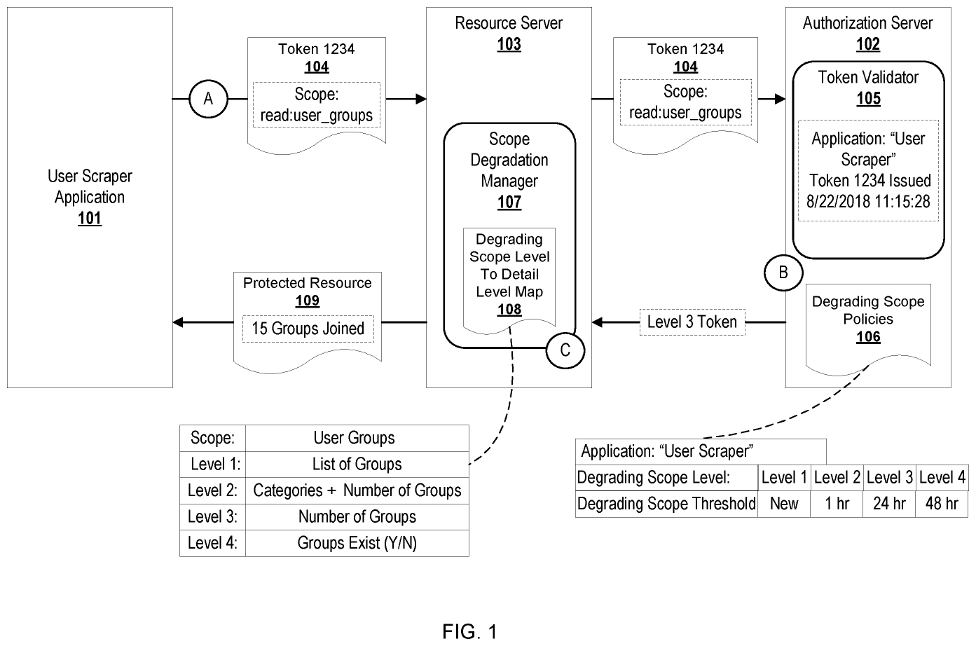

FIG. 1 is a conceptual diagram of scope degradation to limit client application access to protected resources in a token-based authorization framework. FIG. 1 depicts a user scraper application 101 (“application 101”) which requests to access a list of user groups from a resource server 103. An authorization server 102 has previously issued a token 104 to the application 101. The issued token 104 denotes a specific scope of access to protected resources which the resource owner has authorized. For instance, in an OAuth flow, the application 101 may indicate a requested scope in an initial authorization request to the resource owner. After the application 101 presents an authentication grant to the authorization server 102 and the authorization server 102 successfully authenticates the client and validates the authorization grant, the application 101 is issued the token 104.

FIG. 1 is annotated with a series of numbers/letters A-C. These letters represent stages of operations, each of which may be one or more operations. Although these stages are ordered for this example, the stages illustrate one example to aid in understanding this disclosure and should not be used to limit the claims. Subject matter falling within the scope of the claims can vary with respect to the order and some of the operations.

Prior to stage A, a set of degrading scope policies 106 are defined for the application 101 and attached to the authorization server 102. The degrading scope policies 106 may be installed on the authorization server 102 or may be otherwise associated such that the policies are accessible to the authorization server 102. The degrading scope policies 106 may be specific to the application 101 and designate levels of degrading scope which a token validator 105 can assign to the token 104. Degrading scope levels are dictated by token issuance age or token activity age (“access grant age”) and correspond to decreased level of detail or visibility of a user resource as access grant age increases. Access grant age may be determined based on the age of the original access token issued to the application 101 or time elapsed since the application 101 authenticated with the resource server 102 to receive the token 104. For instance, the access grant age may be calculated with respect to the date and time at which the application 101 was first issued an access token. The access grant age may also be calculated based on the most recent authentication event after which the application 101 was issued the token 104. When access grant age satisfies a scope degradation threshold, the degrading scope level which the token validator 105 assigns upon receipt of an access request changes and thus decreases degrading scope level for the resource associated with the token 104.

A scope degradation manager 107 at the resource server 103 defines a representation of protected resources for each scope for which the application 101 may be granted access permissions and for each degrading scope level. The resource server 103 may implement scope degradation levels by creating a masked or otherwise reduced detail representation of the protected resource. For example, data visibility may be reduced with each increasing level of scope degradation, such as by gradually reducing the user post data shared with the application 101 from a user post history to confirmation of whether or not user posts exist. A map 108 indicates implementation of degrading scope levels with associations of detail level with degraded scope levels. The map 108 contains the masked or generalized resource (“resource representation”) for each detail level corresponding to each degraded scope level. The map 108 may be application-specific, such as by associating detail levels with degrading scope levels for the application 101 that differ from associations defined for other client applications. In some cases, the resource server 103 applies a set of associations of degrading scope levels and detail levels across applications accessing a same type of resource and/or across applications of a same type.

At stage A, the application 101 requests a list of user groups from the resource server 103 and presents the resource server 103 with the token 104. Before serving the request, the resource server 103 redirects the request with the token 104 to the authorization server 102 to determine the access scope specified for the token 104.

At stage B, after the authorization server 102 receives the token 104 and redirected request, the token validator 105 searches for a token identifier corresponding to the token 104 within a list of active tokens. The token validator 105 maintains a list of identifiers for each issued access token and associates a time stamp denoting the time the access token was issued for each of the token identifiers. The list may contain additional token identification, such as the application to which the access token was issued. After identifying the token 104 in the list, the token validator 105 determines that the token 104 was issued to the application 101 and calculates the elapsed time between its time of issue and the time of the access request. Based on the calculated duration which the token 104 has been active, the authorization server 102 assigns a degraded scope level to the token 104. The determination of which degraded scope level to assign is based on the degrading scope level policies 106 defined for the application 101. For example, the token 104 may have been issued at 11:15:28 on 8/22/2018 and presented to the authorization server at 12:15:28 on 8/23/2018. The authorization server 102 determines that the token 104 has level 3 degraded scope level after calculating that 25 hours have elapsed since the token 104 was first issued to the application 101 and that a 25-hour period of activity corresponds to the degraded scope level 3 degrade threshold of 24 hours or time window of 24 to 48 hours. The authorization server 102 communicates the assigned access level to the resource server 103.

At stage C, the scope degradation manager 107 determines which resource representation for the user groups scope to share with the client application 101 according to the degraded scope level of the token 104. The scope degradation manager 107 may identify the resource to which the client application 101 is requesting access based on the scope indicated in the initial request which the resource server 103 received. Levels of detail are defined for each degraded scope level to which the token 104 may be authorized access based on the access scope specified for the token 104 granted to the resource owner. For instance, the scope degradation manager 107 may define the map scopes 108 for degraded scope levels 1 through 4 for each of the user groups, user email, and user date of birth scopes for access tokens issued to the client application 101. After receiving the degraded scope level for token 104 from the authentication server 102, the scope degradation manager 107 determines that the client application 101 is requesting to access the user groups scope with level 3 degraded scope level.

After determining which access scope is specified for the token 104 and degraded scope level of the token 104, the scope degradation manager 107 determines the resource representation of the user groups scope to share with the application 101 detail level to be applied. The resource server 103 serves the access request by sharing a representation of the resource at a detail level indicated in the map 108 for the degraded scope level of the token 104. For example, because the token 104 has level 3 degraded scope level, the scope degradation manager 107 identifies that the map 108 indicates that the resource representation of the user groups scope to share corresponds to level 3 degraded scope level is to be the number of groups to which the user belongs. The number of user groups is determined and subsequently shared with the client application 101. The resource server 103 is not to share the full list of user groups as requested because the degraded scope level of the token 104 indicates a detail level of “Number of Groups.”

In subsequent requests in which the application 101 presents the token 104 to the resource server 103 and indicates one or several requested scopes, operations depicted by stages A-C will repeat for the additional requests. Detail level will decrease as the access grant age of the token 104 satisfies each successively greater access grant age threshold.

Though not depicted in FIG. 1, upon expiration or invalidity of the token 104, the application 101 may present a refresh token to the authorization server 102 to obtain a new access token. Upon presenting the newly issued access token to the resource server 103, operations depicted by stages A-C may repeat with the time stamp recorded for the originally issued access token. For example, the token 104 may be assigned degraded scope level 4 prior to expiring. After the authorization server 102 issues the application 101 a new access token, the token validator 105 will not record the time of issuing the new token or assign the new token level 1 degraded scope level. The token validator 105 retains the time of issue of the token 104 and thus aging based on the time of issue of the first access token continues through new token refreshes.

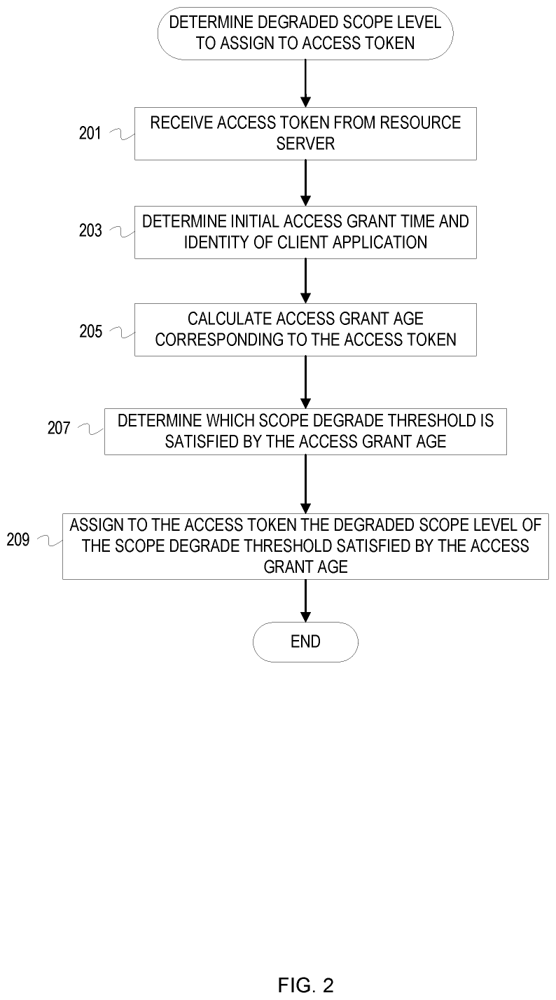

FIG. 2 is a flowchart of example operations for determining a degraded scope level to assign to an access token. The example operations refer to a token validator which executes on an authorization server as performing the depicted operations for consistency with FIG. 1, although naming of software and program code can vary among implementations.

The token validator receives an access token corresponding to an access request which has been redirected from a resource server (201). The access token is issued to a client application which has initiated a request to access a protected resource. The access token is valid for a designated scope of access to a set of protected resources to which the client application has been authorized access.

The token validator determines the time of the initial access grant and the identity of the client application to which the access token was granted (203). The token validator maintains a list of issued access tokens containing an access token identifier, the client application to which the access token was issued, and an access grant time stamp for each access token. The access grant time stamp may correspond to the date and time at which the authorization server first issued the access token to the client application. Alternatively, the access grant time stamp may correspond to the date and time at which the authorization server first authorized the client application access to the protected resource. After receiving the redirected request to access the protected resource, the token validator identifies the access grant time and the client application issuing the request based on the list entry corresponding to the access token.

The token validator calculates the access grant age which corresponds to the access token (205). Access grant age may correspond to the age of an original access token issued to the client application or the duration of time since the client application most recently authenticated and was granted access to designated protected resources. If the access grant age is to be the age of the original access token, the token validator calculates the time elapsed since an access token was first issued. If the access grant age is to be the duration of client application authentication, the token validator calculates the time elapsed since the client application was authenticated and granted the access token which it was last issued. The token validator determines the date and time to use for calculating access grant age based on the access grant time stamp stored in the list of issued access tokens.

The token validator determines which scope degrade threshold is satisfied by the access grant age calculated for the access token (207). Degrading scope policies which are defined at the authorization server may be client application-specific and establish multiple degrading scope levels, each of which corresponds to a scope degrade threshold based on access grant age. For example, the degrading scope policy for the client application issuing the current request may define four access levels. Each of the four access levels has an associated threshold for access grant age. The token validator determines which scope degrade threshold is satisfied based on which of the scope degrade thresholds corresponds to the calculated access grant age. For example, if a level 2 degrading scope level corresponds to a threshold of 1 hour and a level 3 degrading scope level corresponds to a threshold of 24 hours, an access token for which the access grant age is greater than 1 hour and less than 24 hours satisfies the level 2 degrading scope level.

The token validator assigns to the access token the degraded scope level which corresponds to the scope degrade threshold satisfied by the access grant age (209). The token validator identifies the degrading scope level corresponding to the scope degrade threshold which the access grant age satisfies based on the degrading scope policies. Once the degraded scope level has been determined, the token validator communicates the degraded scope level to the resource server from which the access request was redirected.

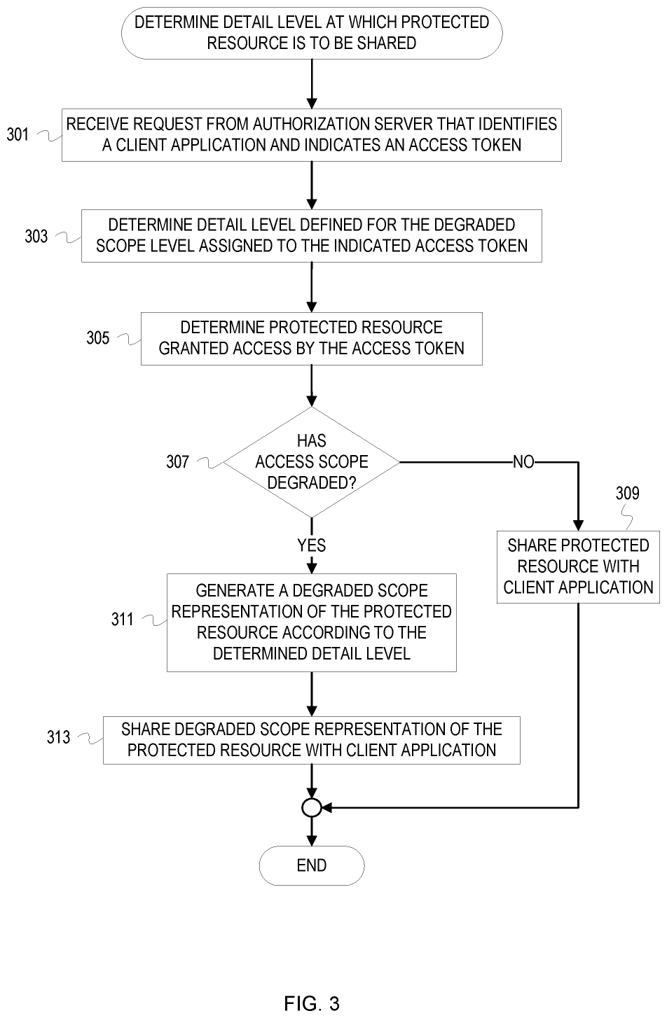

FIG. 3 is a flowchart of example operations for determining a detail level at which a protected resource is to be shared with a client application. The example operations refer to a scope degradation manager executing on a resource server as performing the depicted operations for consistency with FIG. 1, although naming of software and program code can vary among implementations.

The scope degradation manager receives a request from an authorization server which identifies a client application and indicates an access token (301). The resource server received the access token in an initial access request which the client application initiated. The request indicates the identity of the client application and access token as well as a degraded scope level which was assigned to the access token based on access grant age.

The scope degradation manager determines the protected resource detail level which is defined for the degraded scope level (303). The scope degradation manager maintains a map of degraded scope levels and corresponding detail levels for each protected resource. The map may be client application-specific or may be shared between client applications which access a same type of protected resource or are of a same application type. The detail levels within the map indicate successively lower levels of detail with which protected resources should be shared as the degraded scope level increases. For instance, a lowest degraded scope level which indicates that the scope has not yet degraded may indicate that the protected resource is to be shared with the client application without decreasing its level of detail (e.g., an original user email address). A highest degraded scope level may indicate that an affirmation of whether or not the protected resource exists is to be shared (e.g., an indication that a user email address exists).

The scope degradation manager determines the protected resource to which the access token is valid (305). The scope degradation manager may determine the protected resource based on the access request which it initially received and redirected to the authorization server. The scope degradation manager may also determine the protected resource based on the request containing the degraded scope level which it received from the authorization server. The scope degradation manager retrieves the protected resource which the access token has been determined to grant access.

The scope degradation manager determines if the access scope has degraded (307). The scope degradation manager identifies if the detail level corresponding to the degraded scope level indicates that the original protected resource should be shared. For instance, a first degraded scope level may correspond to an indication that the access scope has not degraded and that the protected resource should be shared with the client application without reduction of the level of detail. Additional degraded scope levels which indicate that the protected resource should be shared with reduced detail correspond to a degradation of access scope.

If the access scope has not degraded, the scope degradation manager shares the protected resource with the client application (309). An access scope which has not degraded may indicate that the access token was recently issued and that the access grant age thus does not yet satisfy a scope degrade threshold. The scope degradation manager thus serves the request for access to a protected resource with the protected resource at an unaltered level of detail. The scope degradation manager generates a response to the access request which contains the requested resource and sends the response to the client application.

If the access scope has degraded, the scope degradation manager generates a degraded scope representation of the protected resource according to the determined detail level (311). The scope degradation manager generates the resource which should be shared based on the mapping of the detail level and the protected resource which has been requested. The determined detail level corresponding to the protected resource may indicate information about the protected resource which is to be shared or may indicate how the protected resource should be masked to create the degraded scope representation. For example, the detail level defined for a list of user groups may indicate that a certain characteristic of the protected resource is to be shared (e.g., categories and/or a number of user groups). As another example, the detail level for a user email address may indicate which portion of the email address should be masked at that detail level (e.g., replacing the recipient name with asterisks). The degraded scope representation is created by applying the reduction in detail designated by the detail level, such as by counting the number of items within the protected resource or replacing characters in the protected resource.

The scope degradation manager shares the degraded scope representation of the protected resource with the client application (313). The scope degradation manager serves the request for the protected resource with the degraded scope representation of the protected resource which was generated based on the degraded scope level. The scope degradation manager may store the degraded scope representation of the protected resource for subsequent access requests for which the access token corresponds to the same degraded scope level. The scope degradation manager generates a response to the request to access the protected resource and sends the response which contains the degraded scope representation to the client application. The client application thus receives a representation of the protected resource with a reduced level of detail relative to the original protected resource as a result of access grant aging.

### VARIATIONS

The examples often refer to a “scope degradation manager.” The scope degradation manager is a construct used to refer to implementation of functionality for determining a level of detail with which a protected resource is to be shared with a client application. This construct is utilized since numerous implementations are possible. A scope degradation manager may be a particular component or components of a machine (e.g., a particular circuit card enclosed in a housing with other circuit cards/boards), machine-executable program or programs, firmware, a circuit card with circuitry configured and programmed with firmware, etc. The term is used to efficiently explain content of the disclosure. Although the examples refer to operations being performed by a scope degradation manager, different entities can perform different operations.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 303 and 305 can be performed in inverse order, parallel, or concurrently. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

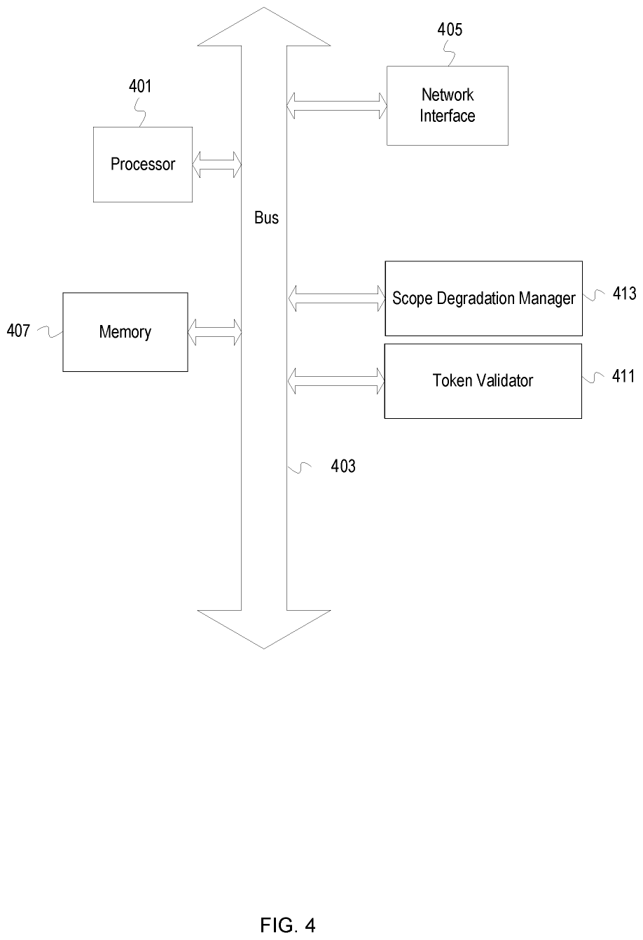

FIG. 4 depicts an example computer system with a token validator and a scope degradation manager. The computer system includes a processor 401 (possibly including multiple processors, multiple cores, multiple nodes, and/or implementing multi-threading, etc.). The computer system includes memory 407. The memory 407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 403 (e.g., PCI, ISA, PCI-Express, HyperTransport® bus, InfiniBand® bus, NuBus, etc.) and a network interface 405 (e.g., a Fiber Channel interface, an Ethernet interface, an internet small computer system interface, SONET interface, wireless interface, etc.). The system also includes a token validator 411 and a scope degradation manager 413. The token validator 411 determines a degraded scope level to assign to an access token based on an access grant age which it calculates. The scope degradation manager 413 determines a level of detail of a protected resource with which to serve a client application request for access based on the degraded scope level assigned to the access token. The token validator 411 and scope degradation manager 413 may operate on the same computer system (e.g., a computer system with a virtual machine operating as an authorization server on which the token validator 411 executes and a virtual machine operating as a resource server on which the scope degradation manager 413 executes). However, the token validator 411 and the scope degradation manager 413 do not necessarily execute on the same computer system. Each entity may execute on a respective server (e.g., authorization server or resource server) distinct from the computer system on which the client application executes. Any one of the previously described functionalities may be partially (or entirely) implemented in hardware and/or on the processor 401. For example, the functionality may be implemented with an application specific integrated circuit, in logic implemented in the processor 401, in a co-processor on a peripheral device or card, etc. Further, realizations may include fewer or additional components not illustrated in FIG. 4 (e.g., video cards, audio cards, additional network interfaces, peripheral devices, etc.). The processor 401 and the network interface 405 are coupled to the bus 403. Although illustrated as being coupled to the bus 403, the memory 407 may be coupled to the processor 401.

While the aspects of the disclosure are described with reference to various implementations and exploitations, it will be understood that these aspects are illustrative and that the scope of the claims is not limited to them. In general, techniques for age-based scope degradation for limiting the level of detail with which protected resources are shared with a client application as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
based on receipt of a first access request that indicates a first access token for a protected resource and that identifies a client application, determining a degraded scope level assigned to the first access token;
retrieving the protected resource that corresponds to the first access token;
determining which of a plurality of detail levels is associated with the degraded scope level;
based on the degraded scope level indicating degraded access scope,
generating a representation of the protected resource with less detail according to the detail level determined to be associated with the degraded scope level; and
communicating a response to the client application to share the representation of the protected resource with the client application.

2. The method of claim 1, wherein determining the degraded scope level assigned to the first access token comprises reading the degraded scope level in the first access request.

3. The method of claim 1, wherein the first access request is from an authorization server.

4. The method of claim 3 further comprising redirecting a second access request from the client application to the authorization server prior to receipt of the first access request, wherein the first access request corresponds to the second access request.

5. The method of claim 1, wherein the first access token is based on an open authorization protocol.

6. The method of claim 1, wherein determining which of the plurality of detail levels is associated with the degraded scope level comprises accessing a data structure that maps degraded scope levels to the plurality of detail levels.

7. The method of claim 1, wherein generating a representation of the protected resource with less detail according to the detail level determined to be associated with the degraded scope level comprises applying a mask to the protected resource to generate the representation.

8. The method of claim 1, wherein generating a representation of the protected resource with less detail according to the detail level determined to be associated with the degraded scope level comprises generating an indication of an attribute of the protected resource.

9. The method of claim 1, wherein generating a representation of the protected resource with less detail according to the detail level determined to be associated with the degraded scope level comprises obfuscating the protected resource to generate the representation of the protected resource.

10. The method of claim 1 further comprising determining the degraded scope level from a plurality of degraded scope levels based on which of a plurality of thresholds is satisfied by an age of the first access token or a duration since access was initially granted.

11. A non-transitory, computer-readable medium having instructions stored thereon that are executable by a computing device to perform operations comprising:
determining a first degradation level assigned to a first access token, wherein the first access token indicates granted scope of access to a protected resource by a first client application;
based on the first degradation level, determining a representation of the protected resource to share with the client application based on a data structure that maps degradation levels to levels of detail, wherein determining the representation comprises accessing the data structure based on the first degradation level;
generating the representation of the protected resource based on a first level of detail of the levels of detail to which the degradation level maps; and
sending the representation of the protected resource to the first client application.

12. The non-transitory, computer-readable medium of claim 11, wherein generating the representation of the protected resource comprises generating a representation of the protected resource with a reduced level of detail according to the first level of detail.

13. The non-transitory, computer-readable medium of claim 12, wherein generating the representation of the protected resource with a reduced level of detail comprises generating an indication of an attribute of the protected resource or applying a mask to the protected resource to generate the representation.

14. The non-transitory, computer-readable medium of claim 11, wherein the first degradation level is based on an age of the first access token or duration of time since the client application was initially granted access.

15. An apparatus comprising:
a processor; and
a computer-readable medium having instructions stored thereon that are executable by the processor to cause the apparatus to,
determine a first visibility level assigned to a first access token based on an age value associated with the first access token, wherein an access scope of a protected resource by an identified client application is defined for the first access token;
retrieve the protected resource that corresponds to the first access token;
determine whether the visibility level corresponds to one of a plurality of reduced visibility levels;
based on a determination that the first visibility level is one of the plurality of reduced visibility levels,
generate a representation of the protected resource with a reduced level of detail according to the first visibility level; and
share the representation of the protected resource with the identified client application.

16. The apparatus of claim 15, wherein the computer-readable medium further has instructions executable by the processor to cause the apparatus to share the protected resource with the identified client application based on a determination that the first visibility level is not one of the plurality of reduced visibility levels.

17. The apparatus of claim 15, wherein the instructions executable by the processor to cause the apparatus to generate a representation of the protected resource with a reduced level of visibility comprise instructions executable by the processor to cause the apparatus to obfuscate or apply a mask to the protected resource to generate the representation.

18. The apparatus of claim 15, wherein the instructions executable by the processor to cause the apparatus to generate a representation of the protected resource with a reduced level of visibility comprise instructions executable by the processor to cause the apparatus to generate an indication of an attribute of the protected resource.

19. The apparatus of claim 15, wherein the instructions executable by the processor to cause the apparatus to determine a first visibility level assigned to the first token comprise instructions executable by the processor to cause the apparatus to determine the first visibility level based on an access request that indicates the first access token.

20. The apparatus of claim 19, wherein the instructions executable by the processor to cause the apparatus to determine the first visibility level comprise instructions executable by the processor to cause the apparatus to determine from the access request a degradation level for the first access token and access a data structure to determine which of the plurality of reduced visibility levels maps to the degradation level.
